(19) United States
(12) Patent Application Publication
(10) Pub. No.: US 2011/0002281 A1
(43) Pub. Date: Jan. 6, 2011

(54) DISCONTINUOUS RECEPTION FOR CARRIER AGGREGATION

(75) Inventors: Stephen E. Terry, Northport, NY (US); Erdem Bala, Farmingdale, NY (US); Guodong Zhang, Syosset, NY (US); Kyle Jung-Lin Pan, Smithtown, NY (US); Sung-Hyuk Shin, Northvale, NJ (US); Jin Wang, Princeton, NJ (US); Peter S. Wang, E. Setauket, NY (US); Paul Marinier, Brossard (CA); Jean-Louis Gauvreau, La Prairie (CA); Philip J. Pietraski, Huntington Station, NY (US); Shankar Somasundaram, London (GB)

Correspondence Address: Woodcock Washburn LLP, 2929 Arch Street, Cira Centre, 12th Floor, Philadelphia, PA, 19104, US

(73) Assignee: INTERDIGITAL PATENT HOLDINGS, INC., Wilmington, DE (US)

(21) Appl. No.: 12/649,054

(22) Filed: Dec. 29, 2009

Related U.S. Application Data
(60) Provisional application No. 61/141,382, filed on Dec. 30, 2008.
(60) Provisional application No. 61/156,930, filed on Mar. 3, 2009.
(60) Provisional application No. 61/162,135, filed on Mar. 20, 2009.
(60) Provisional application No. 61/218,721, filed on Jun. 19, 2009.
(60) Provisional application No. 61/233,953, filed on Aug. 14, 2009.

(51) Int. Cl. H04W 72/04

(52) U.S. Cl. 370/329

(57) ABSTRACT

Discontinuous reception (DRX) operations for wireless communications implementing carrier aggregation are disclosed. Physical downlink control channel implementation for carrier aggregation is also disclosed. DRX methods are disclosed including a common DRX protocol that may be applied across all component carriers, an individual/independent DRX protocol that is applied on each component carrier, and hybrid approaches that are applied across affected component carriers. Methods for addressing the effects of loss of synchronization on DRX, impact of scheduling request on DRX, uplink power control during DRX, and DRX operation in measurement gaps are disclosed.

### CROSS REFERENCE TO RELATED APPLICATIONS

This application claims the benefit of U.S. provisional application Nos. 61/141,382 filed Dec. 30, 2008; 61/156,930 filed Mar. 3, 2009; 61/162,135 filed Mar. 20, 2009; 61/218,721 filed Jun. 19, 2009; and 61/233,953 filed Aug. 14, 2009, which are incorporated by reference as if fully set forth herein.

### FIELD OF INVENTION

This application is related to wireless communications.

### BACKGROUND

Long Term Evolution (LTE) supports data rates up to 100 Mbps in the downlink and 50 Mbps in the uplink. LTE-Advanced (LTE-A) provides a fivefold improvement in downlink data rates relative to LTE using, among other techniques, carrier aggregation. Carrier aggregation may support, for example, flexible bandwidth assignments up to 100 MHz. Carriers are known as component carriers in LTE-A.

LTE-A may operate in symmetric and asymmetric configurations with respect to component carrier size and the number of component carriers. This is supported through the use or aggregation of up to five 20 MHz component carriers. For example, a single contiguous downlink (DL) 40 MHz LTE-A aggregation of multiple component carriers may be paired with a single 15 MHz uplink (UL) carrier. Non-contiguous LTE-A DL aggregate carrier assignments may therefore not correspond with a UL aggregate carrier assignment.

Aggregate carrier bandwidth may be contiguous where multiple adjacent component carriers may occupy continuous 10, 40 or 60 MHz. Aggregate carrier bandwidth may also be non-contiguous where one aggregate carrier may be built from more than one, but not necessarily adjacent component carriers. For example, a first DL component carrier of 15 MHz may be aggregated with a second non-adjacent DL component carrier of 10 MHz, yielding an overall 25 MHz aggregate bandwidth for LTE-A. Moreover, component carriers may be situated at varying pairing distances. For example, the 15 and 10 MHz component carriers may be separated by 30 MHz, or in another setting, by only 20 MHz. As such, the number, size and continuity of component carriers may be different in the UL and DL.

In LTE, a wireless transmit/receive unit (WTRU) may be configured with a discontinuous reception (DRX) functionality that allows the WTRU to monitor the physical downlink control channel (PDCCH) discontinuously, therefore saving power consumption at the WTRU.

The PDCCH may provide DL assignments and UL grants for shared channels. The existing DRX operation and parameter settings in LTE have been designed to be specifically applicable to only one carrier and is not applicable to systems implementing carrier aggregation. Analog front-end and analog-to-digital conversion in WTRUs implementing carrier aggregation may account for a major fraction of the WTRU power consumption. Efficient methods for receiving on a low bandwidth are essential for making LTE-A WTRUs attractive from a power-consumption point-of-view. But constantly receiving signals on all component carriers is not power efficient. A DRX protocol and the associated parameters with consideration of carrier aggregation are needed for efficient power consumption.

### SUMMARY

Discontinuous reception (DRX) operations for wireless communications implementing carrier aggregation are disclosed. Physical downlink control channel implementation for carrier aggregation is also disclosed. DRX methods are disclosed including a common DRX protocol that may be applied across all component carriers, an individual/independent DRX protocol that is applied on each component carrier, and hybrid approaches that are applied across affected component carriers. Methods for addressing the effects of loss of synchronization on DRX, impact of scheduling request on DRX, uplink power control during DRX, and DRX operation in measurement gaps are disclosed.

### BRIEF DESCRIPTION OF THE DRAWINGS

A more detailed understanding may be had from the following description, given by way of example in conjunction with the accompanying drawings wherein:

FIG. 1 is an embodiment of a wireless communication system/access network of long term evolution (LTE);

FIG. 2 are example block diagrams of a wireless transmit/receive unit and a base station of the LTE wireless communication system;

FIG. 3 shows an example of a discontinuous reception (DRX) Cycle;

FIG. 4 illustrates an example of wireless communications using carrier components;

FIG. 5 shows DRX cycle alignment among different component carriers;

FIG. 6 illustrates operation of DRX cycles among different component carriers; and

FIG. 7 illustrates DRX Operation when activated by a primary carrier.

### DETAILED DESCRIPTION

When referred to hereafter, the terminology “wireless transmit/receive unit (WTRU)” includes but is not limited to a user equipment (UE), a mobile station, a fixed or mobile subscriber unit, a pager, a cellular telephone, a personal digital assistant (PDA), a computer, or any other type of device capable of operating in a wireless environment. When referred to hereafter, the terminology “base station” includes but is not limited to a Node-B, a site controller, an access point (AP), or any other type of interfacing device capable of operating in a wireless environment.

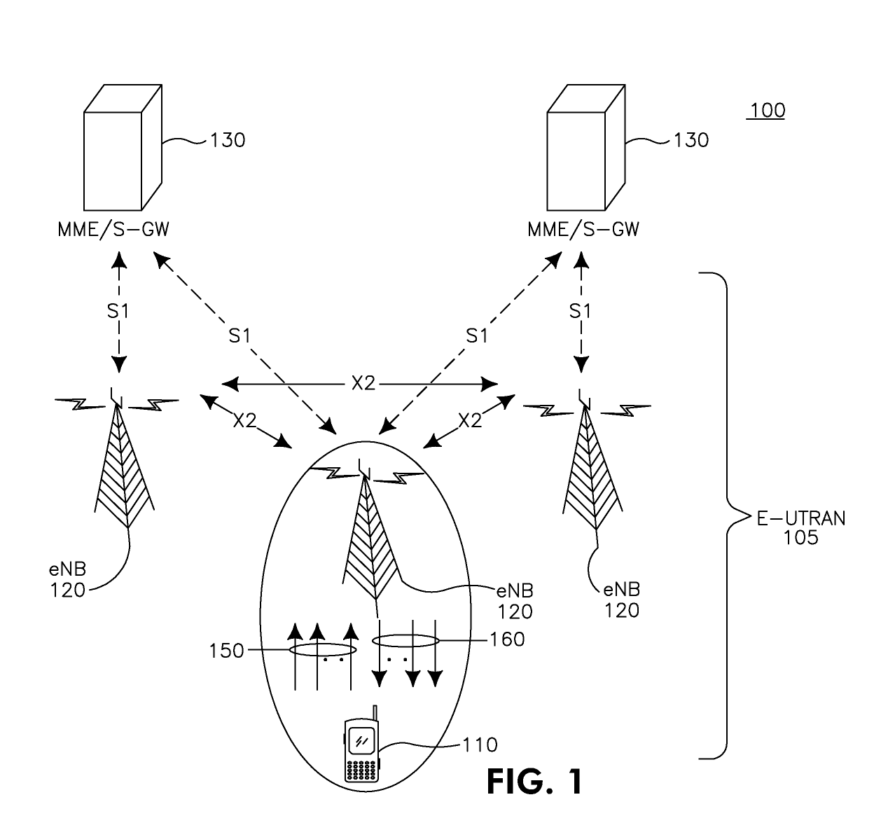

FIG. 1 shows a Long Term Evolution (LTE) wireless communication system/access network 100 that includes an Evolved-Universal Terrestrial Radio Access Network (E-UTRAN) 105. The E-UTRAN 105 includes a WTRU 110 and several evolved Node-Bs, (eNBs) 120. The WTRU 110 is in communication with an eNB 120. The WTRU 110 and eNB 120 may communicate using uplink component carriers 150 and downlink component carriers 160. The eNBs 120 interface with each other using an X2 interface. Each of the eNBs 120 interface with a Mobility Management Entity (MME)/Serving GateWay (S-GW) 130 through an S1 interface. Although a single WTRU 110 and three eNBs 120 are shown in FIG. 1, it should be apparent that any combination of wireless and wired devices may be included in the wireless communication system access network 200.

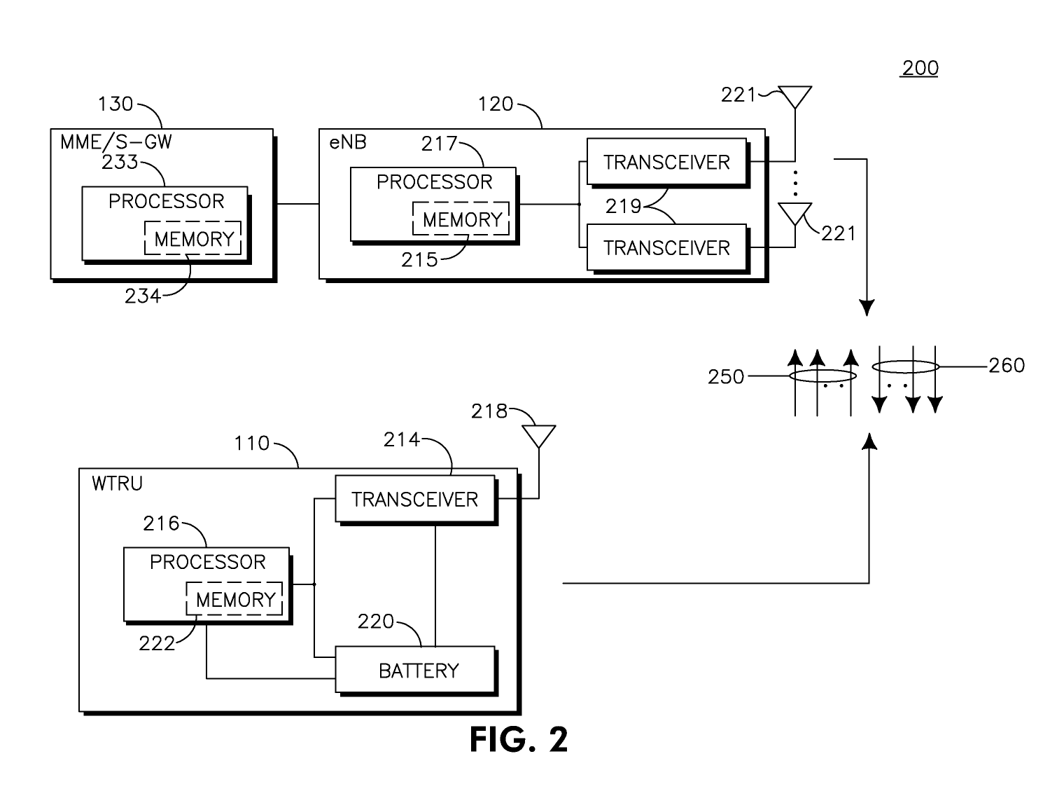

FIG. 2 is an example block diagram of an LTE wireless communication system 200 including the WTRU 110, the eNB 120, and the MME/S-GW 130. As shown in FIG. 2, the WTRU 110 is in communication with the eNB 120 and both are configured to perform a method wherein uplink transmissions from the WTRU 110 are transmitted to the eNB 120 using multiple component carriers 250, and downlink transmissions from the eNB 120 are transmitted to the WTRU 110 using multiple downlink carriers 260. The WTRU 110, the eNB 120 and the MME/S-GW 130 are configured to perform DRX for a carrier aggregation implementation.

In addition to the components that may be found in a typical WTRU, the WTRU 110 includes a processor 216 with an optional linked memory 222, at least one transceiver 214, an optional battery 220, and an antenna 218. The processor 216 is configured to perform DRX for a carrier aggregation implementation. The transceiver 214 is in communication with the processor 216 and the antenna 218 to facilitate the transmission and reception of wireless communications. In case a battery 220 is used in the WTRU 110, it powers the transceiver 214 and the processor 216.

In addition to the components that may be found in a typical eNB, the eNB 120 includes a processor 217 with an optional linked memory 215, transceivers 219, and antennas 221. The processor 217 is configured to perform DRX for a carrier aggregation implementation. The transceivers 219 are in communication with the processor 217 and antennas 221 to facilitate the transmission and reception of wireless communications. The eNB 120 is connected to the Mobility Management Entity/Serving GateWay (MME/S-GW) 130 which includes a processor 233 with an optional linked memory 234.

The WTRU may be configured by a radio resource control (RRC) entity with discontinuous reception (DRX) functionality that allows it to monitor a physical downlink control channel (PDCCH) discontinuously on one or more component carriers. DRX operation may be based on one or more of a Long DRX cycle, a DRX Inactivity timer, a hybrid automatic repeat request (HARQ) round trip time (RTT) Timer, a DRX Retransmission Timer, a Short DRX Cycle and a DRX Short Cycle Timer.

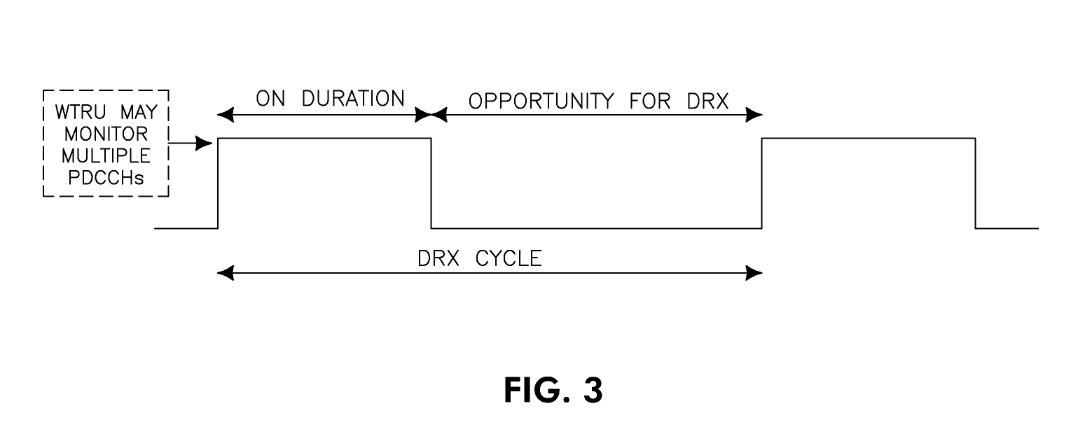

When DRX is configured as illustrated in FIG. 3, the Active Time for one or more component carriers may include time under multiple situations. The Active Time is the period of time that the WTRU is awake. It may include time when the On Duration Timer, the DRX Inactivity Timer, the DRX Retransmission Timer or the Contention Resolution Timer for random access is running. It may also include time when a Scheduling Request is pending or when an uplink grant for a pending HARQ retransmission can occur. It may further include time when a PDCCH indicating a new transmission addressed to the cell radio network temporary identifier (C-RNTI) or Temporary C-RNTI of the WTRU has not been received after successful reception of a Random Access Response.

A WTRU may enter DRX for one or more component carriers when the On Duration timer or DRX Inactivity timer expires, or a DRX Command (carried in a medium access control (MAC) control element (CE)) is received in the subframe. Note that in a LTE system, a DRX command may be used to force the WTRU to enter DRX.

During the Active Time, for a PDCCH-subframe, except if the subframe is required for uplink transmission for half-duplex, frequency division duplex (FDD) WTRU operation, and except if the subframe is part of a configured measurement gap, the WTRU monitors the PDCCH. If the PDCCH indicates a downlink (DL) transmission or if a DL assignment has been configured for this subframe, then the WTRU starts the HARQ RTT Timer for the corresponding HARQ process and stops the DRX Retransmission Timer for the corresponding HARQ process. If the PDCCH indicates a new transmission (DL or UL), then the WTRU starts or restarts the DRX Inactivity timer. The PDCCH may provide DL assignments and UL grants for shared channels.

DRX operations and/or procedures nominally operate with respect to PDCCH operations. In radio resource control (RRC) Connected State, there are two possible methods of PDCCH operation, hierarchical PDCCH operation and non-hierarchical PDCCH operation.

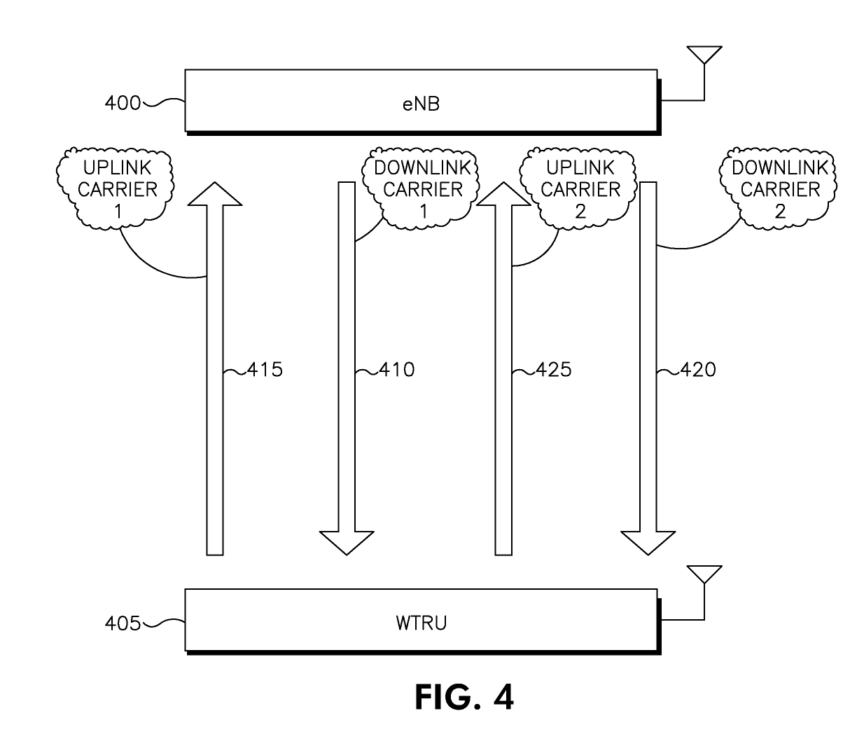

In hierarchical PDCCH operation, a PDCCH received on any DL component carrier (CC) may provide DL assignments for any DL CC and uplink (UL) grants for any UL CC. For example, as shown in FIG. 4, a PDCCH received on a DL CC 1 410 from a eNB 400 to a WTRU 405 may provide DL assignments for DL CC 2 420 or UL grants for UL CC 1 415 and UK CC 2 425. This may be implemented by adding a CC identifier to PDCCH command formats. It may be noted that PDCCH reception is not required on all active DL CCs. A WTRU may receive PDCCH on a subset of the DL CCs for which the WTRU may receive shared channel and other DL transmissions. With hierarchical PDCCH operation, the WTRU may be configured to receive PDCCH on a single DL CC, a subset of the DL CCs or all DL CCs. Within the set of DL CCs for which PDCCH is received, different WTRUs may receive PDCCH on different sets of DL CCs.

In the hierarchical PDCCH case for active DL CCs that are not configured for PDCCH reception, there are currently no defined DRX procedures since existing DRX procedures are based on PDCCH reception. There are, however, periods of reception for channels other then PDCCH, such as but not limited to, DL shared channel (DSCH), DL synchronization channel (SCH), random access response (RAR) and periods where reception on these DL CCs are deactivated. For these types of CCs, WTRU reception is based on shared channel scheduling and other DL transmissions known to the WTRU. For example, reception may be based on when a PDCCH of another CC dynamically allocates, or may dynamically allocate, a DL SCH on this CC; when a semi-persistent scheduling (SPS) configuration determines a DL SCH transmission on this CC; if a UL HARQ feedback requests a retransmission on this CC; or when a RAR may be configured on this CC. During other periods, the WTRU may disable reception on the DL CC without PDCCH. It should also be noted that for DL CCs with PDCCH independent of the PDCCH DRX procedures, reception is also enabled for the criteria listed above.

In non-hierarchical PDCCH operation, a PDCCH received on a DL CC may provide DL assignments for the DL CC carrying the PDCCH and UL grants for a single known UL CC that is paired with the DL CC for which PDCCH is received. This limitation exists because there is no CC identifier included in the PDCCH command formats. With this method, PDCCH reception and DRX operation is required on all activated DL CCs. The set of active CCs may be different for different WTRUs.

For the non-hierarchical PDCCH and for the hierarchical PDCCH, several methods of dynamic enabling and disabling of PDCCH reception across DL CCs are described herein.

Disclosed herein are DRX operations that may be implemented for wireless communications using carrier aggregation. In one embodiment, a common DRX state is applied across all configured and activated component carriers. In another embodiment, DRX states are applied on an individual or independent basis for each component carrier. In yet another embodiment, a hybrid approach DRX is effected by events across the affected component carriers. Embodiments disclosed herein are illustrative and other combinations are discernible from the discussed embodiments.

A common DRX protocol embodiment applied across all configured and active component carriers is disclosed herein. In this embodiment, component carriers receive a common DRX configuration. In this embodiment, all aggregated component carriers have a common DRX state. The WTRU may enter and leave DRX on all carriers at the same time. That is, the WTRU may use one set of DRX parameters that simultaneously affects DRX across all activated carriers. The Active Time (or on time) is the same for activated carriers, and may take into account events, such as PDCCH reception, HARQ retransmission timer and other DRX triggering criteria. For example, the Inactivity timer may be started (or restarted) whenever a PDCCH indicating a new transmission (in UL or DL) is received on any component carrier.

The rules for starting and stopping the above timers may include those for existing single-carrier DRX operation. The Inactivity timer may be started or restarted every time a PDCCH indicating a new UL grant or DL assignment is received from any component carrier. In addition, if a separate “Inactivity timer for other carrier” may be defined, this timer may also be started or restarted every time a PDCCH indicating a new UL grant or DL assignment is received from any component carrier. It may also be possible that the “Inactivity timer for other carrier” be started or restarted when the PDCCH indicates a new UL grant or DL assignment for the “other carrier”.

Disclosed herein are DRX protocols, methods or procedures that are applied on an independent or individual CC basis. In this embodiment, DRX procedures on each DL CC operate independently. Once PDCCH reception is activated on a CC, events controlling DRX are independent for each CC. The WTRU may be receiving PDCCH on some CCs while not receiving PDCCH on other CCs. The DRX Active Time on each CC is determined independently for each CC.

In this embodiment, DRX parameters such as but not limited to On Duration timer, Inactivity timer, DRX period, may be configured using one or a combination of methods. In a first configuration, the same set of DRX parameters may be configured for all carriers in the aggregated bandwidth. The DRX cycles, On Durations, and Inactivity and Retransmission timers may be configured with the same values for each DL CC.

In another configuration, a different set of DRX parameters may be configured for each carrier in the aggregated bandwidth. The DRX Cycle offsets and On Durations may be staggered between CCs. The Inactivity and Retransmission timers may vary between CCs. In addition, the DRX parameters may scale among carriers according to the bandwidth of a component carrier. For illustrative purposes, the values of the DRX parameters may be relative to the bandwidth of each component carrier.

For the individual or independent based DRX, the following DRX protocol may be applied. For each DL carrier with PDCCH reception configured, the DRX protocol of each carrier may include existing DRX protocols based on single carrier. For each carrier, the WTRU maintains, that is setting, resetting and running, a separate set of DRX timers such as but not limited to, On Duration timer, Inactivity timer, retransmission, short DRX cycle, long DRX cycle, and HARQ RTT timer, independent of other carriers. When On Duration timer, retransmission and Inactivity timers expire for this carrier, the WTRU enters DRX for this carrier. This DRX protocol may also be applicable to the second and third hybrid configurations described herein.

Disclosed herein are hybrid DRX protocols, methods or procedures that may be applied to CCs.

In one hybrid configuration, a same set of DRX parameters may be configured for a group of carriers that may be supported by one radio frequency (RF) front end receiving a particular frequency band in the WTRU and a different set of DRX parameters may be configured for groups of carriers that may be supported by different RF front end receivers or receiver frequency bands. DRX parameters may scale among carrier groups according to the sum bandwidth of the carriers in the group.

In a second hybrid configuration, DRX parameters may be configured differently for carrier groups supported by different RF front end receivers or receiver frequency bands. Within the same carrier group, DRX parameters may scale among carriers according to the bandwidth of each component carrier.

In a third hybrid configuration, one or more DL carriers may be defined as a “primary CC(s).” Other DL carriers, also with PDCCH reception configured, may be defined as “secondary CCs”. DRX parameters may be configured differently for the primary carrier(s), or the same or similar set of parameters may be configured for each secondary carrier. Additionally, the primary carrier may have the full set of DRX parameters, and the secondary carriers may have a reduced set of DRX parameters. For example, the secondary carriers may not have DRX cycles and On Durations configured.

In this case, it may be possible for activity on the primary carrier to enable PDCCH reception on secondary carriers, and therefore, it may not be necessary to apply DRX Cycles on the secondary CCs. This may be implemented by triggering events on the primary carrier that initiate the Inactivity timers or DRX cycles on some or all secondary carriers. The triggering events to activate and deactivate PDCCH reception on secondary CCs may be explicitly signaled by the radio resource controller (RRC), medium access controller (MAC) or PDCCH commands, or implicit events such as DL or UL allocations on a primary CC to activate reception and no PDCCH reception within one or more Active Time periods on the specific secondary CC or the primary CC to deactivate CC reception. The initiation of the Inactivity timer on a secondary carrier may also be conditional to the On Duration timer running on the primary carrier. Note that between the time the triggering event was received and the Inactivity timer, or DRX cycles is effectively re-started, a delay of a few subframes may be required. For example, if the new data indicator on the primary CC(s) is received on subframe_k, the Inactivity timer on secondary CC(s) may only start at subframe_k+j, where j is a few subframes which should allow the secondary CC(s) to wakeup, synchronize and adapt to the channel. Although discussed with respect to the third hybrid configuration, activity on the primary carrier to enable PDCCH reception on secondary carriers is applicable to all embodiments discussed herein.

The setting of other parameters, such as the On Duration timer, DRX short cycle timer, DRX cycle period, are discussed herein. The Inactivity timer of a secondary carrier may be no longer than that of a primary carrier. In this way, the WTRU may be more likely to enter DRX on a secondary carrier than one a primary carrier. The On Duration timer of the primary carrier may be no less than that of a secondary carrier. The DRX cycle period of a secondary carrier may be no less than that of the primary carrier. The DRX short cycle timer of a secondary carrier may be no less than that of the primary carrier.

It may be possible that certain triggering events or activity occurring on one or more “primary CC(s)” may change the DRX operation state of one or more secondary CC(s). The triggering may even activate or deactivate CC reception or for the CC to operate with short DRX cycle from long DRX cycle—this redefines the periodicity of the DRX cycle to follow the SHORT_DRX_CYCLE instead of the LONG_DRX_CYCLE.

One trigger to change the DRX state of the secondary CC(s) may be the reception of a DL grant with a new data indicator. In this scenario, the network may configure the secondary CC(s) with very long LONG_DRX_CYCLE and relatively short SHORT_DRX_CYCLE while configuring the primary CC(s) with relatively short LONG_DRX_CYCLE and SHORT_DRX_CYCLE. With such a scheme, in a period of infrequent data activity, the secondary CC(s) may exhibit a very low duty cycle but a primary CC(s) may wake more often to monitor incoming grants. As soon as some new allocation is correctly received on the primary CC(s) with a new data indicator, the secondary CC(s) may follow a short DRX cycle which may allow the network to allocate data quicker.

Explicit triggers received on one or more primary CCs such as a MAC control element (CE) or PDCCH command may explicitly define which secondary CC(s) may enable or disable DRX cycles or change DRX state. This method may also be used to avoid sending multiple MAC CE or PDCCH commands to all configured CC(s) if the network wishes to force the WTRU to enable DRX cycles or to follow a short DRX cycle for all CC(s). It may be able to send a single MAC CE OR PDCCH DRX command to the primary CC(s). The explicit triggers disclosed herein are applicable to all embodiments discussed herein.

DRX parameters configuration for secondary carriers may follow the embodiments discussed herein.

The primary CC may be dynamically configured to be the last component carrier that received a PDCCH indicating a new transmission in the UL or DL. In this scenario, a long Inactivity timer is set for the carrier that is dynamically-configured as the new primary carrier and a short Inactivity timer is set for the other carriers. A similar approach may be applied to an On duration timer and other DRX parameters.

In one embodiment, one or more primary carriers may have common or independent configured DRX cycles and On Duration timers. Disabling a DRX operation on secondary carriers may be accomplished by triggering conditions on the primary carrier. The secondary carriers may have independent Inactivity, HARQ Round Trip Time (RTT) and DRX Retransmission timers to maintain reception independently or one set of timers to maintain common reception of other carriers once activated by the primary carrier. The eNB may signal to the WTRU which carrier(s) may be used as the primary carrier(s), and which carriers are not the current primary carrier(s) via PDCCH or MAC CE signaling. The timing to change the primary carrier(s) may be contained in the PDCCH or MAC CE signaling or may be pre-defined as X transmission time interval (TTIs) later after receiving the triggering indication. The configuration of parameters on the new primary carrier(s) is described hereinbelow. The eNB may also signal to the WTRU which carrier(s) may be used as primary through RRC messages during the initial carrier configuration or during a RRC Reconfiguration. This may be done implicitly by not providing specific DRX parameters as described herein for secondary CC(s) such as On_Duration_Cycle. This embodiment is applicable to all embodiments disclosed herein.

If there is on-going DL or UL transmission on the current primary carrier(s), either the eNB may signal to WTRU to switch the primary carrier(s) immediately or may allow the WTRU to finish the existing HARQ transmission and then change the primary carrier(s). In this case, the short Inactivity timer may be activated to continue the on-going data transmissions.

In a fourth hybrid configuration, a group of CC(s) may be defined as activity occurring on any of the CC(s) or receiving triggers, such as MAC CE or PDCCH command, on any CC of the group that impacts the DRX state or starts the Inactivity_timer or DRX cycles of the other CC(s) as disclosed herein for hybrid configuration three. The CC(s) inside the group may still have either common or independent DRX operation. The group of CC(s) may be a subset of all the configured CC(s). In contrast to the third hybrid configuration, this may allow more flexibility for the network in determining to which CC(s) it may send new data or other explicit triggers, such as a MAC CE or PDCCH Command that would trigger a change on the other CC of the group. As in the third configuration, the initiation of the Inactivity timer on a secondary carrier may also be conditional to the On Duration timer running on the primary carrier. The subset of CC(s) for which the occurrence of activity triggers the inactivity_timer or DRX cycle for a given CC may be different from one CC to another, and configured by a higher layer. Equivalently, higher layers may configure the subset of CC(s) which have the property that occurrence of activity on them triggers the inactivity_timer or DRX cycle on other CC(s). In other words, any active DL CC receiving PDCCH may be considered a primary CC and other DL CCs not currently actively receiving PDCCH may be considered secondary CCs. The grouping concepts disclosed herein are applicable to all embodiments disclosed herein.

For each of the configurations and/or embodiments discussed herein, an additional DRX parameter called “Inactivity/On Duration Timer for Other Carrier” may be provided. Such a parameter may be configured with a smaller value than the normal “Inactivity timer” or “On Duration timer”, and its purpose may be to control how long the WTRU may monitor PDCCH on a carrier when a triggering event occurs on another carrier, as described herein below. The benefit of this additional parameter over just configuring a carrier-specific Inactivity timer is that it may make it possible to have a larger Inactivity timer or on duration timer for the carrier from which data happens to be received compared to the other carriers.

For hybrid based DRX embodiments or configurations, the following DRX protocols may be applied. These protocols may provide independent or common DRX protocols for each carrier plus the interaction between different carriers for activation and deactivation of PDCCH reception.

In one implementation, explicit signaling of activation/deactivation commands via RRC signaling, MAC CE or a new PDCCH command may be provided. In an example, a DRX command received on RRC, MAC or PDCCH of one carrier may be used to enable or disable PDCCH reception and associated DRX procedures on other carriers; enter or leave DRX on a specified carrier; or change the DRX cycle to be used from long to short as explained in hybrid configuration 3.

In another implementation, explicit PDCCH activation/deactivation methods may be used. In one example, RRC, MAC CE, or PDCCH signaling may identify specific DL CCs for which PDCCH reception and associated DRX procedures are enabled and or disabled. An UL CC may be paired with a DL CC for providing feedback for the DL CC. Whenever the DL CC is deactivated or activated, the paired UL CC transmissions are implicitly deactivated or activated.

A component carrier switching embodiment is disclosed herein that is applicable to the common DRX, independent DRX and hybrid DRX approaches disclosed herein. In this embodiment, CCs receive the DRX commands and/or parameters non-synchronously. In this embodiment, the subset of component carriers that the WTRU monitors depends on a pre-signaled pattern as well as on which timer(s) are running. The potential change of component carrier at every DRX cycle has the benefit of allowing the WTRU to assess (and report) channel quality on all CCs. The change of DL CC being monitored may also be accompanied by a change of CC for UL transmissions.

The higher layers or entities may use any repeating activation/deactivation sequence. For example, the higher entities may provide a sequence of component carriers, or possibly a sequence of subsets of component carriers, for example, (f1, f2, f3) or (f1, [f2+f3], f4). Every time the WTRU starts the next DRX cycle timer, it selects the next component carrier (or subset of component carriers) in the sequence and monitors this component carrier or subset of component carriers at least until the DRX cycle starts. Such a component carrier may be designated as the “current carrier” in the following discussion. It may be possible that the sequence contains a single component carrier (or a single subset of component carriers), in which case the current carrier effectively acts as a “primary” carrier. The “current carrier(s)” may stay unchanged until the next time the WTRU starts the next DRX cycle. Alternatively, the “current carrier(s)” may be deleted upon expiration of the On Duration timer.

A carrier is monitored if one or a combination of the following conditions is met: the On Duration timer is running and the carrier is a current carrier; the Inactivity timer is running (in case an “Inactivity timer for other carrier” is not defined); the Inactivity timer is running and the carrier is a current carrier; the “Inactivity timer for other carrier” is running; or the “Retransmission timer” is running for a HARQ process associated with this carrier.

Alternatively, an “active time” may be defined for each component carrier. For a “current carrier”, the active time includes the time while the On Duration timer, the Inactivity timer, the “Inactivity timer for other carrier” (if configured), a Retransmission timer for a HARQ process associated with this carrier, or the Contention Resolution timer is running. For a non-current carrier, the active time includes the time while the “Inactivity timer for other carrier” (if configured), a Retransmission timer for a HARQ process associated with this carrier or the “Inactivity Timer” (if the “Inactivity timer for other carrier” is not defined) is running.

Depending on the PDCCH signaling method, UL and DL shared channel transmission may also be enabled/disabled on the UL & DL CCs associated with the particular CC PDCCH. For the case of Hierarchical PDCCH operation, before enabling and/or after disabling PDCCH reception, the CC may be configured for DL shared channel reception. For each DL CC, PDCCH reception activation and deactivation may be independent of shared channel reception and transmission. For the case of non-hierarchical operation, enabling and disabling PDCCH reception may be coordinated with DL shared channel reception. For each DL CC, PDCCH reception activation and deactivation may also activate shared channel reception. Also, for the non-hierarchical case, if the DL CC is paired with an UL CC that is not paired with another DL CC, the activation or deactivation of UL CC transmission may also be coordinated with enabling and disabling the PDCCH reception on the DL CC for which the UL CC is paired.

In another implementation, new PDCCH formats with code points may be used for enabling and disabling PDCCH reception of other carriers for LTE-A WTRUs that may be applied in LTE-A. If such a PDCCH with code points explicitly indicating monitoring of other carriers is received on one carrier in subframe n, then the WTRU may activate or deactivate PDCCH reception and associated DRX procedures on those carriers from the sub-frame n+k. Either On Duration timer and/or Inactivity timer may be started/restarted or the DRX cycle may be initiated at the configured offset and period on those carriers at subframe n+k, where k is a predefined parameter. This method may also be used for a group of users that may receive a common PDCCH (received on a carrier) with code points indicating DRX of other carriers.

Further methods are disclosed for explicit PDCCH, MAC CE or RRC signaling methods that may activate PDCCH reception on other CCs. In one method, an “Inactivity timer” or alternatively (if configured) the “Inactivity timer for other carrier” may be started or restarted on the identified CC(s). In this case, it may not be necessary to have DRX cycles and On Durations as part of the DRX procedures on the activated CCs. DRX operation may just consist of Inactivity, RTT and retransmission timers. When these timers expire the CC may disable PDCCH reception until another PDCCH reception activation trigger event occurs. The CCs in this case without DRX cycles and/or On Durations may be considered secondary CCs. One or more primary CCs may apply configured DRX cycles and On Durations. Alternatively, once the Inactivity or other timers (for example, retransmission timer) expire, the WTRU may apply a configured DRX cycle and On Durations until a PDCCH reception deactivation triggering event occurs. The initiation of the “Inactivity timer” or alternatively, if configured, the “Inactivity timer for other carrier” due to activity on another carrier, may be conditional to the On Duration timer running on this other carrier. “Activity” on another carrier may mean reception of PDCCH or physical downlink shared channel (PDSCH) for this WTRU on this carrier (for a downlink carrier) or transmission of physical uplink shared channel (PUSCH) (for an uplink carrier).

In another method, DRX cycles may be started or restarted on the identified CC(s) in the activation signal. Similar to the Inactivity timer method described above, after DRX timers have expired, DRX cycles may automatically continue or have to be reactivated by additional triggering events. Also, similarly, primary CC(s) are CCs that have repeating DRX Cycles and On Durations, and secondary CCs may or may not have repeating DRX Cycles and On Durations.

In yet another method, the configured DRX cycle (period and offset) and On Duration may be activated on the identified CC(s). When PDCCH reception is activated on a DL CC, the configured DRX Cycle and On Durations may be applied, and the Inactivity and/or On Duration timers may not be automatically applied. PDCCH reception starts when the DRX Cycle configuration starts the On Duration timer.

In still another method, the activation and deactivation may be for one CC, for all other carriers, or for a pre-configured subset of carriers, or for a subset of carriers signaled in the same PDCCH.

Implicit PDCCH reception activation/deactivation methods may also be used. Similar to explicit activation/deactivation, implicit triggering events may enable/disable PDCCH reception and associated DRX procedure on other carriers, or enter or leave DRX on a specified carrier. In one implicit PDCCH activation/deactivation method, when a PDCCH indicating a new transmission (in UL or DL) is received on one carrier, the WTRU may enable PDCCH reception and associated DRX procedures on other DL CCs. Similar to the explicit signaling methods, the CC PDCCH reception may start or restart the DRX “Inactivity Timer”/“Inactivity Timer for another carrier”, or start the On Duration timer with repeating DRX Cycles or requiring timer reactivation events without repeating DRX Cycles. It may also or alternatively start the DRX Cycle and On Duration at the configured offset and period. The implicit activation of PDCCH reception on other CCs may be limited to triggering on a “primary CC”. When this occurs one or more “secondary CCs” are activated. The implicit activation of PDCCH reception on other CCs may be restricted to the condition that the “On Duration” timer is running on a “primary CC”. Also, similar to explicit methods, the activation/deactivation may be for one CC, for all other carriers, or for a configured subset of carriers that may be signaled by higher layers.

In another implicit triggering method, a number of Active Time periods without PDCCH reception may disable PDCCH reception and associated DRX procedures until the next activation triggering event enabling PDCCH reception. The number of Active Time periods may be configured and may be associated with existing logic entering “long DRX”. The method of deactivation may (the triggering and/or the CC's being deactivated) be specific to each secondary CC's. PDCCH reception and the associated DRX procedure may be disabled on each specific DL CC for which the implicit triggering criteria was reached. Alternatively, secondary CC's may be deactivated and may trigger primary CCs. In this case PDCCH reception and associated DRX procedures may be disabled on secondary CCs by implicit triggering criteria on primary CCs.

With independent DRX, the WTRU may have a number of implicit schemes to follow when DRX is on different carriers. For example, in the case of timing alignment timer expiration, the WTRU may be on a short DRX cycle on the primary carrier but might be on a long DRX cycle on the other carriers. The WTRU may be running a timing alignment timer (TAT) on the primary carrier. When the TAT expires on the primary carrier the WTRU may implicitly change the DRX cycles on the other carriers to a short DRX cycle from a long DRX cycle.

In the case of handover, the WTRU may be on 2 carriers and could be on long DRX cycle on one carrier (primary carrier) and on short or no DRX cycle on the other carrier. Also the WTRU may be measuring on a third carrier. The moment WTRU sends a measurement report on the first carrier or primary carrier, the WTRU might terminate the DRX cycle on the primary carrier as well as the other carriers or at the least move the secondary carriers to a short DRX cycle. The WTRU might keep this new configuration until it is determined that a handover is no longer needed or a handover is done.

In the case of S-measure and other measurements on serving carrier (primary carrier), the WTRU might be on short DRX on both the primary carrier and the secondary carrier. The WTRU might be measuring both the primary and secondary carriers periodically, but if the WTRU determines that the primary carrier is above a particular threshold then the WTRU might switch the secondary carrier to long DRX mode since the primary carrier might have sufficient signal strength to provide the throughput the WTRU needs.

In the case of change of services, the WTRU might need a number of carriers so that it can achieve high throughputs in short periods of time. So the WTRU might not be on DRX in any of the carriers, but in case the WTRU starts using a service like voice over IP, for which it might need only one carrier, the WTRU might switch to long DRX on all the other carriers and may keep this configuration till it changes it services again.

For independent DRX across CCs with primary carrier activation of secondary carriers, the DRX operation of a primary carrier may include existing DRX protocols. For the primary carrier, the WTRU may maintain a separate set of DRX timers such as but not limited to On Duration timer, Inactivity timer, retransmission, short DRX cycle, long DRX cycle, and HARQ RTT timer, independent of other carriers. When Active Time, On Duration, retransmission and Inactivity timer, has expired for the primary carrier, the WTRU enters DRX on this carrier.

In this case, primary carrier activation of secondary carriers may be executed under the following conditions. In a first condition, when a DRX activation command is received on the primary carrier, secondary carriers may be activated. This may be accomplished by explicit signaling of RRC, MAC CE or PDCCH code point. In another condition secondary carriers may be activated when a PDCCH indicating a new UL or DL transmission PDCCH reception is enabled. Similarly, PDCCH reception may be disabled by not receiving PDCCH indicating new UL or DL transmissions.

With either explicit or implicit activation/deactivation, the following applied. Inactivity or DRX cycles are initiated on secondary carriers and therefore simplifying the DRX operation of the secondary carriers. The secondary carriers may not have configured DRX cycles and On Duration timers. The secondary carriers may not automatically wake periodically for PDCCH reception. DRX on the secondary carriers may be disabled by either explicit signaling or implicit triggering conditions on the primary carrier. The secondary carrier DRX operation maintains Inactivity, HARQ RTT and DRX retransmission timers independently of the primary carrier DRX operation. DRX Cycles and On Duration periods may be enabled on secondary carriers. Once PDCCH reception is enabled on a secondary CC, DRX operates in a similar way to the triggering CC. In this case, once activated, although independent operation, the DRX procedures are the same on the activated CC as for the CC which triggered the activation.

The set of primary carrier(s) and secondary carrier(s) may be pre-signaled by higher layers.

In addition to carrier-specific DRX protocol for each carrier, different carriers' DRX procedures may also interact via either DRX command such as a MAC CE command or PDCCH activity as disclosed herein. The On Duration timer and Inactivity timer of the primary carrier may be controlled by one of the following methods. In a first method, the Inactivity timer and On Duration timer may be controlled by PDCCH activity or MAC CE on the primary carrier. If a PDCCH or MAC CE indicating a new transmission (in UL or DL) is received on the primary carrier, the WTRU may start or restart the DRX Inactivity Timer of the primary carrier. If a PDCCH or MAC CE indicates a primary carrier switch without new transmission (in UL or DL), the WTRU may start the On Duration timer on the new primary carrier. If a PDCCH or MAC CE indicates a primary carrier switch with new transmission (in UL or DL) in subframe n, the WTRU may start the On Duration timer and DRX Inactivity Timer on the new primary carrier from the sub-frame n+k, where k is a predefined parameter. Also, the WTRU may stop the On Duration timer and Inactivity Timer on the old primary carrier from sub-frame n+k. If a PDCCH or MAC CE indicates an immediate switch of primary carrier, which has unfinished transmission (in UL or DL) on a current primary carrier in subframe n, the WTRU may start the DRX Inactivity timer on the new primary carrier and continue the transmission from the sub-frame n+k, where k is a predefined parameter. Also, the WTRU may stop the On Duration timer and Inactivity Timer on the old primary carrier from sub-frame n+k.

In a second method, the On Duration timer or Inactivity timer is controlled by PDCCH activity on all carriers. If a PDCCH indicating a new transmission (in UL or DL) is received on any of aggregated carriers in sub-frame n, the WTRU may start or restart the On Duration timer or DRX Inactivity Timer of the primary carrier from the sub-frame n+k, where k is a predefined parameter. The On Duration timer and Inactivity timer of a secondary carrier may be controlled by one of the following methods. In a first sub-method, the inactivity timer may be controlled by PDCCH activity on the same (secondary) carrier. If a PDCCH indicating a new transmission (in UL or DL) is received on this secondary carrier, the WTRU may start or restart the Inactivity Timer for this secondary carrier. The PDCCH activity of this carrier may not affect the On Duration timer or DRX Inactivity timer of other carriers. In a second sub-method, the Inactivity timer may be controlled by the PDCCH activity on one or several or all secondary carriers or even the primary carrier. If a PDCCH indicating a new transmission (in UL or DL) is received on any of those carriers in sub-frame n, the WTRU may start or restart the On Duration timer or DRX Inactivity Timer for this secondary carrier from the sub-frame n+k. In case the PDCCH indicates the new transmission is received on a different carrier, the Timer may be started or restarted in case the On Duration timer is running on this different carrier.

In another embodiment, PDCCH-based explicit activation may be used. New PDCCH formats with code points used for the purpose of indicating monitoring of other inactive carriers for LTE-A may be used WTRUs may then work in the LTE-A system. If such a PDCCH with code points explicitly indicating monitoring of one or several inactive carriers is received on a carrier (no matter whether it is a primary or secondary carrier) in subframe n, the WTRU may start to monitor those carriers indicated in PDCCH from the sub-frame n+k and the On Duration timer may be started/restarted on those carriers at sub-frame n+k, where k is a predefined parameter.

In another embodiment, MAC-CE-based activation may be used. The DRX command may be carried in the MAC control element (CE) indicating entering DRX or wake up from DRX on one or several carriers for LTE-A. The DRX command may explicitly indicate the index of carrier(s) that the WTRU may monitor (for PDCCH). The short_DRx cycle might only be configured for the secondary carriers so that when the (entering) DRX command on MAC_CE is received, the WTRU may directly enter into the long_DRX cycle on the secondary carriers; whereas in the primary carrier, the WTRU may enter into the short_DRX cycle when the MAC_CE is received. MAC CE may be used to stop the on-going Inactivity timer or force the WTRU to transmit from short to long DRX cycle on either primary or secondary carriers.

Alternatively for the primary carrier On duration, Inactivity, retransmission and HARQ RTT timers may work as they currently do for the existing single UL/DL carrier operation. Secondary carriers may not have DRX cycles or On Duration timers and may be activated by the primary carrier triggering initiation on Inactivity timers on the secondary carriers. In addition to the Inactivity timer, the secondary carriers may maintain independent HARQ RTT and DRX retransmission timers.

In case the WTRU sends an uplink control message (such as scheduling request), or measurement report or any other uplink signaling message, the WTRU may start monitoring both primary or secondary carriers to check whether the DL response message from the network is received on the secondary carrier. Once the DL response message is received, either on the primary or the secondary carrier, the WTRU may stop monitoring the secondary carriers.

Disclosed herein are DRX operations that are applicable to all embodiments discussed herein.

When the WTRU is in idle mode, it will wake up to listen for paging at preconfigured paging occasions. In one embodiment, the WTRU may monitor preconfigured component carrier, for example the primary carriers, for paging carried on PDCCH. In such a scenario, if the WTRU receives a page for some critical information, such as earthquake and tsunami warning system (ETWS) information, then WTRU may start monitoring all the component carriers and start the corresponding DRX cycle on every component carrier. In case of a system information change on the primary carrier, the WTRU might decide to switch to monitor another component carrier if the DRX cycle on the other component carrier provides the WTRU with potentially more power savings. Since the WTRU is in Idle mode, the WTRU may not inform the network of this change.

In another embodiment, the WTRU may monitor several preconfigured carriers for paging carried on the PDCCH. In yet another embodiment, the WTRU may monitor all component carriers within the aggregated bandwidth for paging carried on PDCCH. Although the WTRU may be monitoring one or several preconfigured carriers for paging information, the carrier may change based on a preconfigured pattern and timing. In this case, the WTRU may tune to different carrier(s) for paging and synchronize with the eNB.

In the case of multiple carriers, the WTRU may have to periodically measure the component carriers to ensure that the quality of all component carriers may be monitored at some level. In such a case, even though the WTRU may follow the DRX cycle on the primary carrier, the WTRU may have to keep track of the DRX cycles on the other component carriers and make measurements at the appropriate intervals to meet the performance requirements.

With different values of Inactivity and DRX timers on primary and secondary carriers, the WTRU may lose synchronization on the secondary carrier. To recover from such a loss in synchronization, the WTRU may implicitly or otherwise use one of the following procedures. In one example method, the WTRU may use the same value of DRX timers on the secondary carriers as on the primary carriers when loss of synchronization is detected irrespective of the values configured by the network.

In another method, the WTRU may have a predefined DRX value per carrier which it may switch to in case of loss of synchronization. In this case when the WTRU loses synchronization on a given carrier, it may switch to the new DRX value on the carrier till it achieves synchronization. Alternatively, the WTRU may switch to the new DRX value on all the carriers till it achieves synchronization.

In yet another method, the WTRU may use random access channel (RACH) on the primary carrier to recover the loss of synchronization. It may in another method terminate DRX cycle complete on the secondary carriers until synchronization is achieved or it may terminate DRX cycle on all carriers until synchronization is achieved.

Synchronization may be lost when there is no transmission activity across all carriers. There is one loss of synchronization timer that is reinitialized if an UL transmission occurs on any of the UL carriers. When the synchronization timer expires, all carriers enter a loss of synchronization state. When an UL transmission is needed or any other synchronization triggering event occurs, a RACH procedure may be initiated on the primary carrier.

Alternatively, there may be one synchronization timer per carrier. When the synchronization timer expires for a specific carrier, the WTRU may count that carrier as the carrier for loss in synchronization. WTRU may then initiate a RACH procedure on that carrier to recover synchronization. If the carrier on which synchronization turns out to be the primary carrier, the WTRU may switch to a secondary carrier as the primary carrier implicitly and send a signal on the primary carrier to inform the network. Once the WTRU achieves synchronization on the previous primary carrier, then the WTRU may switch back or may continue with its mode of operation.

Disclosed herein is the impact of a scheduling request (SR) on DRX. In existing systems, a single SR may be triggered at any sub-frame for a WTRU. In a carrier aggregation implementation, the triggered SR may be transmitted on any one of the aggregated carriers. Regardless, the SR may be transmitted on the UL carrier. Where the corresponding UL scheduling grant (via PDCCH) is transmitted affects the DRX operation.

In one scenario, if the corresponding uplink scheduling grant may be transmitted on the primary carrier, then the Active time of the primary carrier may be extended to ensure the WTRU may monitor the expected PDCCH. In another scenario, if the corresponding uplink scheduling grant may be transmitted on a predetermined downlink carrier, then the Active time of the predetermined downlink carrier may be extended to ensure that the WTRU monitors the expected PDCCH. For example, the index of the downlink carrier may be predetermined by mapping to the index of the uplink carrier where the associated SR was transmitted. Note that the predetermined downlink carrier may be either a primary carrier or a secondary carrier.

If the corresponding uplink scheduling grant may be transmitted on one out of a predetermined set of carriers, then the Active time of all carriers within the predetermined set of carriers may be extended to ensure that the WTRU may monitor the expected PDCCH.

Alternatively, the physical uplink control channel (PUCCH) resources for SR may be configured on multiple component carriers via RRC signaling.

Disclosed herein is UL power control in DRX. When a carrier is in DRX, the WTRU may not be able to perform path loss measurement for that carrier. Alternatively, the WTRU may measure path loss for a period of “On Duration.” In discontinuous transmission (DTX), the WTRU measures path loss at least using the primary carrier(s) having the least DRX cycle period. The averaging method (or averaging filter coefficient) for path loss may be different in DTX, as compared to non-DTX. In addition, when entering DRX, the WTRU resets the closed loop accumulation function.

Disclosed herein is DRX operation in measurement gaps. In measurement gaps, the WTRU monitors the signal level and signal quality of neighbor cells on other frequencies and cells on other radio access technologies (RATs). Depending on the WTRU capability and the measurement object, interruption of the PDCCH monitoring over multiple carriers may be required. For example, a WTRU capable of independent (standalone) cell search configured with a number of CC(s) smaller than the maximum number of simultaneous CC(s) it can support, then monitoring of PDCCH during Active time may continue for all configured CC(s) during measurement gaps.

In contrast, a similar WTRU configured with the same number CC(s) than the maximum number of simultaneous CC(s) it can support, the WTRU may predict or assess whether if at least one configured CC(s) is in opportunity for the DRX during the measurement gap. If yes, then monitoring of PDCCH during Active time may continue for all configured CC(s) during measurement gaps. If not, then the WTRU may stop monitoring PDCCH for a particular CC(s). The selection of which CC(s) monitoring may be interrupted needs to be coordinated with the network.

Selection may be done by the network signaling the carrier ID that may be impacted by the measurement gap in measurement configuration. Alternatively, the WTRU may select the carrier ID impacted by the measurement gap based on some implicit rules such as the highest carrier ID of the configured CC(s) or the highest carrier ID of the secondary CC(s). If a WTRU is not capable of independent cell search, this lack of capability may be signaled to the network, and in this case, PDCCH monitoring on all CC(s) configured may not be done during a measurement gap.

As denoted herein, the primary carrier may be used to monitor for a PDCCH and may wake up on a more frequent manner.

Disclosed herein are further DRX operations that are applicable to all embodiments discussed herein.

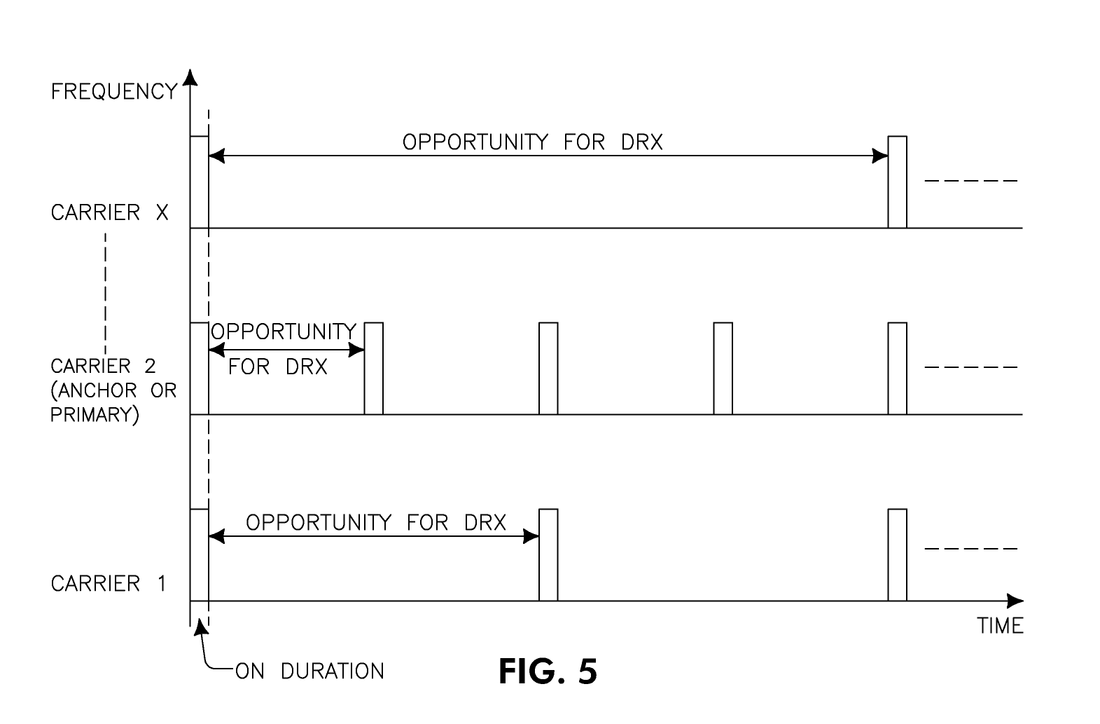

Disclosed herein are methods for addressing alignment of DRX cycles. In one embodiment, if all component carriers are configured with DRX operations, then different DRX cycles may be used for different carriers. These different DRX cycles may be aligned. This means that the DRX cycle lengths of different carriers may be in an integer relation. For example, the DRX cycle length of one carrier may be integer multiples of the DRX cycle of another carrier. This is illustrated in FIG. 5 where it can be seen that carrier 1, carrier 2, . . . , through carrier X, have DRX cycles that are integer multiples of each other.

The relationship between short and long DRX cycles for one carrier may still be the same as existing DRX operations. However, the lengths of short and long DRX cycles of different carriers may be different.

In cases where the secondary carriers are configured with DRX cycles that are longer than that of the primary carrier, then the DRX cycles in those secondary carriers may be N times the DRX cycle of the primary carrier. N may be either an odd or even number. For example, if the long DRX cycle of the primary carrier is M subframes, then the DRX cycle of the secondary carrier may be NM subframes.

The starting point, defined as the sub-frame where the on-duration timer is started, of aggregated carriers may be aligned. This may be implemented by letting N_{offset}_{_{—}}_{primary} (in the range of 0 to N−1) and N_{offset}_{_{—}}_{secondary} (in the range of 0 to NM−1) denote the DRX start offsets for primary and secondary carriers, respectively. Then, N_{offset}_{_{—}}_{secondary} mod N=N_{offset}_{_{—}}_{primary}. This permits all of the carriers to wake up at the same moment after NM subframes.

In the case where no short and long DRX may be used for secondary carriers, then the secondary carriers may be in the longest DRX cycle defined in the RRC connected state. The longest DRX cycle in RRC connected state may be equal to the DRX value in evolved packet system (EPS) connection management (ECM) idle mode.

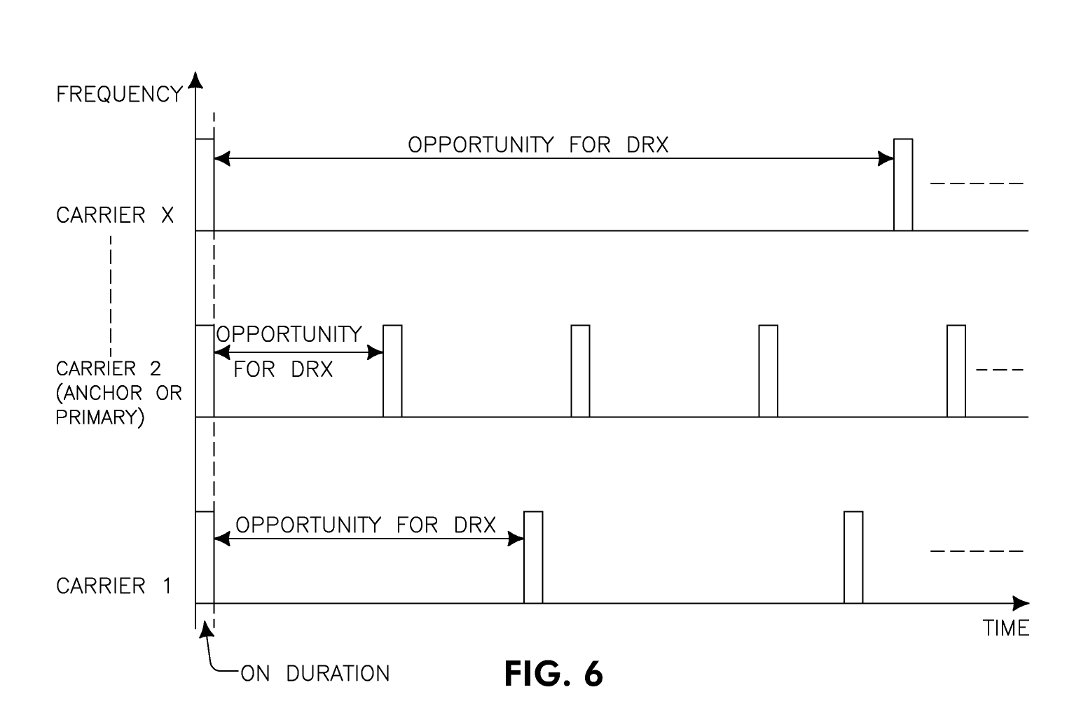

In another embodiment, alignment of DRX cycles may not have an integer relationship. Different carriers may wake up (start on-duration timer) at different sub-frames. In this case, a single carrier wakes up at each moment, therefore WTRU may save power. This is illustrated in FIG. 6 where carrier 1, carrier 2 through carrier X have DRX cycles that are not in an integer relationship. In this case, there may be no requirement that the lengths of the DRX cycles of different carriers be in an integer relationship with each other. Multiple carriers may wake up at the same time if they are activated by the primary carrier when a PDCCH indicates DL/UL transmission. Once all carriers are activated by the primary carrier, they follow the same configurations as the primary carrier. For example, the carriers may use the same timers such as but not limited to, on-duration timer, inactivity timer, and HARQ RTT timer. In some cases, the secondary carrier may have a longer DRX cycle length than that of the primary carrier.

In yet another embodiment, the primary carrier(s) may be configured with periodic DRX cycle(s). This means that the primary carrier may wake up and sleep according to pre-configured parameters. Secondary carriers may not wake up and sleep in a periodic way. Instead these secondary carriers may by default be in the sleep mode and wake up when they are activated by the primary carrier. Once these secondary carriers are activated by the anchor carrier, they follow the same configurations as configured for the primary carrier. This means that the same parameters used for the primary carrier may be applied to the secondary carriers when they are awoken for operations.

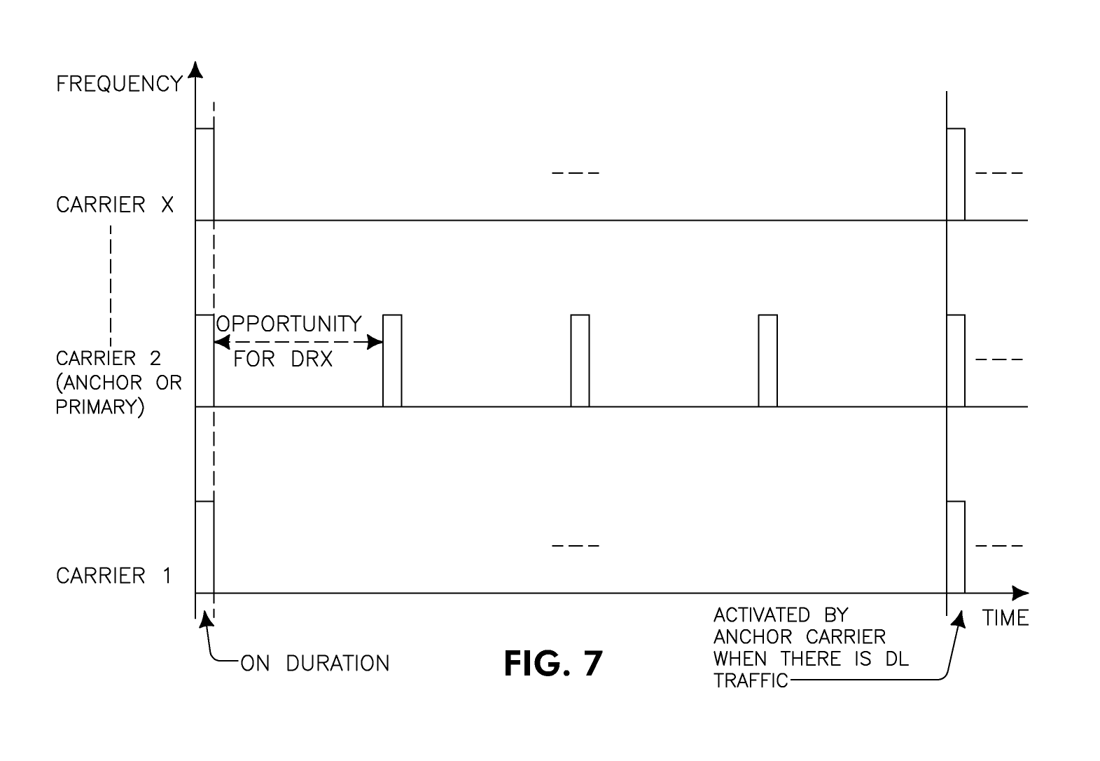

FIG. 7 illustrates DRX Operation when activated by a primary carrier. In this operation, the sleep cycle of a secondary carrier, such as carrier 1, may be infinite and activated by a primary carrier. For example, when there is no DL or UL data transmission, the secondary carriers may sleep forever unless they are activated by a primary carrier when the WTRU detects a DL/UL grant in the PDCCH carried by the primary carrier. The primary carrier, shown as carrier 2 in FIG. 7, may wake up periodically to read the PDCCH. If a DL/UL assignment is not contained in the PDCCH then the primary carrier will go into the sleep cycle again. If the primary carrier detects a DL/UL assignment then its inactivity timer is triggered. The secondary carriers may also be triggered by the primary carrier to wake up for the potential data operations. The parameters configured for the primary carrier may be applied to the secondary carriers. Once the data operations are finished, primary and secondary carriers may go to sleep again.

In another embodiment, a subset of component carriers may be activated by the primary carrier upon reception of a PDCCH with an assignment or grant. When receiving a PDCCH for a DL assignment, it may be allowable to activate a subset of the component carriers based on the DL traffic load. For example, the DL assignment may indicate that a subset of the component carriers of the aggregated carriers may be needed to support the DL traffic. In this case, a subset of these carriers may be awakened from their sleep mode for the DL transmission. Which carriers may be activated may be contained in the PDCCH or MAC CE. Component carriers that are not needed may continue their sleeping cycle.

Although features and elements are described above in particular combinations, each feature or element can be used alone without the other features and elements or in various combinations with or without other features and elements. The methods or flow charts provided herein may be implemented in a computer program, software, or firmware incorporated in a computer-readable storage medium for execution by a general purpose computer or a processor. Examples of computer-readable storage mediums include a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs).

Suitable processors include, by way of example, a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), and/or a state machine.

A processor in association with software may be used to implement a radio frequency transceiver for use in a wireless transmit receive unit (WTRU), user equipment (UE), terminal, base station, radio network controller (RNC), or any host computer. The WTRU may be used in conjunction with modules, implemented in hardware and/or software, such as a camera, a video camera module, a videophone, a speakerphone, a vibration device, a speaker, a microphone, a television transceiver, a hands free headset, a keyboard, a Bluetooth® module, a frequency modulated (FM) radio unit, a liquid crystal display (LCD) display unit, an organic light-emitting diode (OLED) display unit, a digital music player, a media player, a video game player module, an Internet browser, and/or any wireless local area network (WLAN) or Ultra Wide Band (UWB) module.

What is claimed is:

1. A method for discontinuous reception (DRX) at a wireless transmit/receive unit (WTRU), comprising:
receiving a DRX configuration with DRX state information; and
determining the DRX state based on the DRX state information, wherein the DRX state is applicable to at least two component carriers the WTRU is configured to receive.

2. The method of claim 1, wherein the DRX state is common to the at least two component carriers.

3. The method of claim 1, wherein multiple DRX states, based on the DRX state information, are determined for the at least two component carriers.

4. The method of claim 2, wherein multiple DRX states, based on the DRX state information, are determined for different component carriers.

5. The method of claim 1, wherein DRX timers for activated component carriers are affected in a same manner according to the DRX state information.

6. The method of claim 1, wherein DRX timers for activated component carriers are affected independently according to the DRX state information.

7. The method of claim 1, wherein DRX timers are maintained for component carriers carrying a physical downlink control channel (PDCCH).

8. The method of claim 1, wherein DRX timers are maintained for component carriers not carrying a physical downlink control channel (PDCCH).

9. The method of claim 1, wherein the DRX state information includes at least a resource allocation trigger, a scheduling request trigger, PDCCH reception, predetermined channel reception, random access response, semi-persistent scheduling configuration, hybrid automatic repeat request operations, and a paging trigger.

10. The method of claim 1, further comprising:
activating/deactivating DRX operation on at least one secondary component carrier based on a triggered event on a primary component carrier.

11. The method of claim 10, wherein the triggered event is signaled by at least one of a radio resource controller (RRC), medium access controller (MAC) or PDCCH command.

12. The method of claim 10, wherein the triggered event is determined from resource allocations on the primary component carrier.

13. The method of claim 10, wherein the DRX state affected by the triggered event has a delayed response.

14. The method of claim 10, wherein the triggered event indicates at least one affected secondary carrier.

15. The method of claim 1, further comprising:
receiving a component carrier DRX status command.

16. The method of claim 15, wherein the component carrier DRX status command includes at least component carrier indication and time to change status information.

17. The method of claim 15, wherein the component carrier DRX status command is sent over at least one of PDCCH signaling, MAC Control Element (CE), initial component carrier configuration signaling or RRC reconfiguration.

18. The method of claim 1, wherein the at least component carriers is predetermined.

19. The method of claim 1, wherein activation/deactivation of uplink component carrier transmission is coordinated with enabling/disabling the PDCCH reception on a paired downlink component carrier.

20. The method of claim 1, further comprising:
receiving PDCCH code points indicating which component carriers to monitor; and
monitoring indicated component carriers at a predetermined offset.

21. The method of claim 1, further comprising:
activating/deactivating DRX operation on at least one secondary component carrier based on a PDCCH indicating a new transmission on another component carrier.

22. The method of claim 1, wherein some of the DRX state information is applicable to all configured and activated component carriers.

23. The method of claim 3, wherein the DRX state is common to at least some component carriers.

24. The method of claim 21, wherein at least a subset of the secondary carriers apply a common DRX state information.

25. The method of claim 21, wherein at least a subset of the secondary carriers independently apply a specific DRX state information.

26. The method of claim 1, further comprising:
using one of a predetermined DRX timer value or at least one primary component carrier DRX timer for at least one secondary component carrier in response to loss of synchronization with the secondary component carriers.

27. The method of claim 1, further comprising:
terminating at least some component carriers in response to loss of synchronization with at least one secondary component carrier.

28. The method of claim 1, further comprising:
extending an active time of an uplink scheduling grant carrying component carrier to monitor for a PDCCH.

29. The method of claim 1, further comprising:
extending an active time of at least one component carrier to monitor for a PDCCH on a condition that one of the at least one component carrier carries an uplink scheduling grant.

30. The method of claim 1, further comprising:
performing a measurement during a predetermined measurement gap; and
continuing monitoring of PDCCH during active time for at least one configured and activated component carrier during the measurement gap based on predetermined conditions.

31. The method of claim 30, wherein the monitoring of the one configured and activated component carrier during the measurement gap is interrupted.

32. A wireless transmit/receive unit (WTRU) with discontinuous reception (DRX), comprising:
a receiver configured to receive a DRX configuration with DRX state information; and
a processor configured to determine the DRX state based on the DRX state information, wherein the DRX state is applicable to at least two component carriers the WTRU is configured to receive.
